(19) United States
(12) Patent Application Publication
(10) Pub. No.: US 2009/0209169 A1
(43) Pub. Date: Aug. 20, 2009

(54) Method and apparatus to facilitate development of baby

(76) Inventors: Jon K. Curry, Chino Valley, AZ (US); Kevin B. Walters, Prescott, AZ (US)

Correspondence Address: TOD R NISSLE, PO BOX 55630, PHOENIX, AZ, 85078, US

(21) Appl. No.: 12/070,160

(22) Filed: Feb. 15, 2008

(51) Int. Cl. A63H 33/00; H04N 5/64; A47D 9/00; A47C 31/00

(52) U.S. Cl. 446/227; 348/836; 5/93.1; 5/658

(57) ABSTRACT

A programmable system facilitates the development of a baby zero to six months old while the baby lies on its back in a baby crib. The programmable system includes an adjustable two dimensional display screen mounted on an adjustable arm to position the two dimensional display screen above the baby and generally parallel to the mattress of the crib. Real life audio-visual correlation models are shown on the display screen.

This invention relates to a method to facilitate the development of a young baby.

More particularly, the invention relates to a system to facilitate the development of a one to six month old baby when the baby is in a crib.

When a baby is quite young, the current market trend to assist the development of a baby is, in addition to putting rattles and other toys in the crib, using a mobile that the baby can view while on its back in the crib. This market trend looks to have existed for many years and to be well-entrenched. There are a great many of such mobiles in the market. See for example at www.nextag.com/baby-crib-mobiles/search-html the Sunshine Kids Amazing Garden Musical Mobile, Princess Musical Crib Mobile, Liliblue Musical Mobile, Stevens MiGi Sweet Crib Mobile, Cotton Tale Dolly Musical Mobile, 123 Musical Mobile, Baby Annabel Musical Crib Mobile, Banana Fish National Velvet Musical Mobile, USC Crib Mobile, Cleveland Browns Crib Mobile, Deluxe Symphony in Motion Mobile with remote, Camel and Chocolate Paisley Musical Crib Mobile, and over three-hundred other baby mobiles. The mobiles include toy animals and other three-dimensional objects that hang from the mobiles, include lights, and include music. The distance of the mobiles from the bottom of the crib often is adjustable, typically to three different elevations.

There do not appear to be any problems associated with baby crib mobiles that dictate moving away from the current trend, or that would reasonably dictate a set of predictable solutions. However, as is always the case, it would be desirable to provide a new system to facilitate the development of a young baby.

Accordingly, it would be highly desirable to provide an improved system to promote the development of a young baby, particularly a system that is unpredictable in view of apparatus available in connection with the current market trend.

Therefore, it is an object of the instant invention to provide an improved system to facilitate the development of a young baby aged one to six months.

This, and other further objects of the invention, will be apparent to those skilled in the art from the following detailed description thereof, taken in conjunction with the drawings, in which:

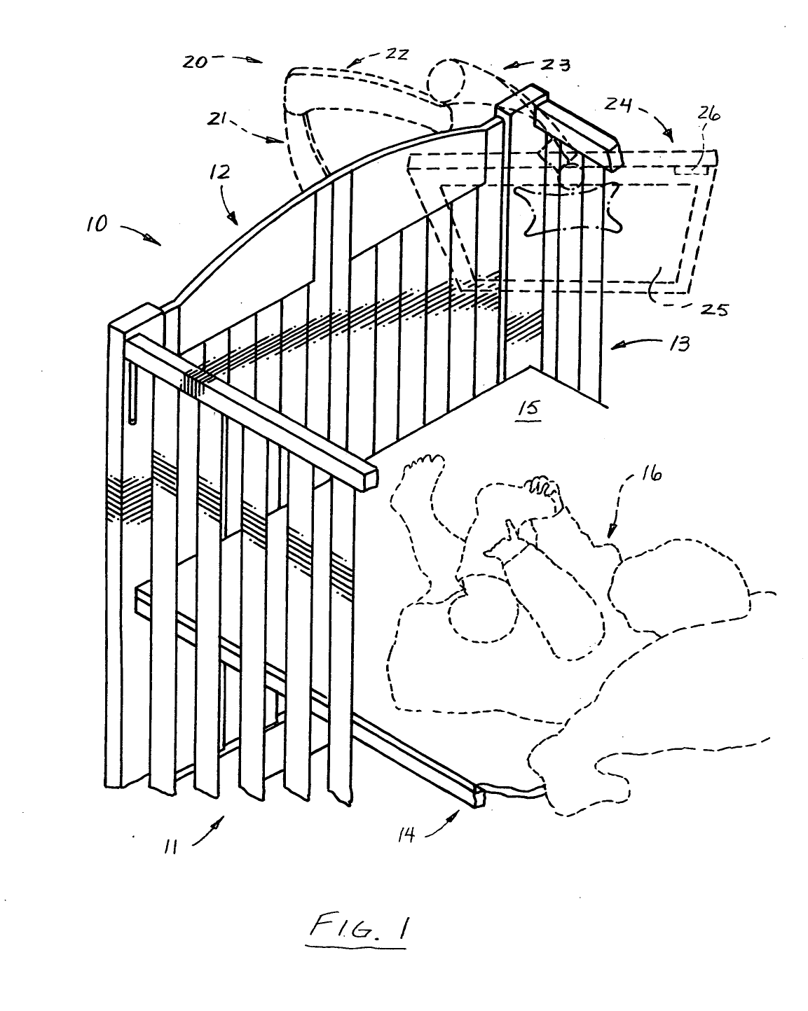

FIG. 1 is a perspective view illustrating a baby crib provided with apparatus constructed in accordance with the invention;

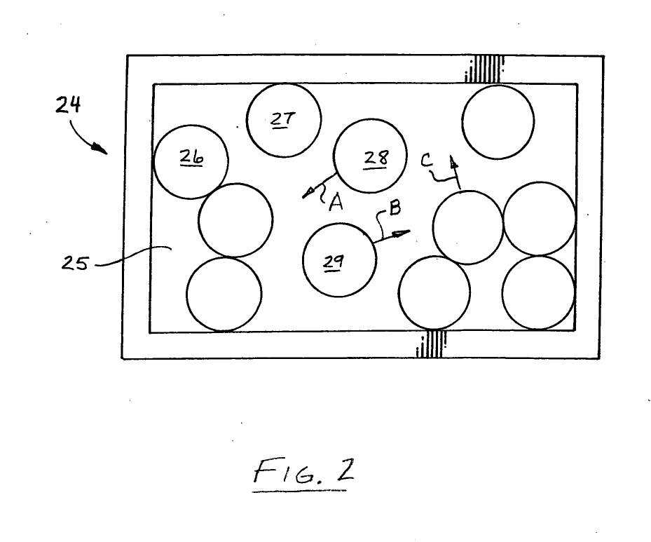

FIG. 2 is a front elevation view illustrating a screen displaying moving bubbles;

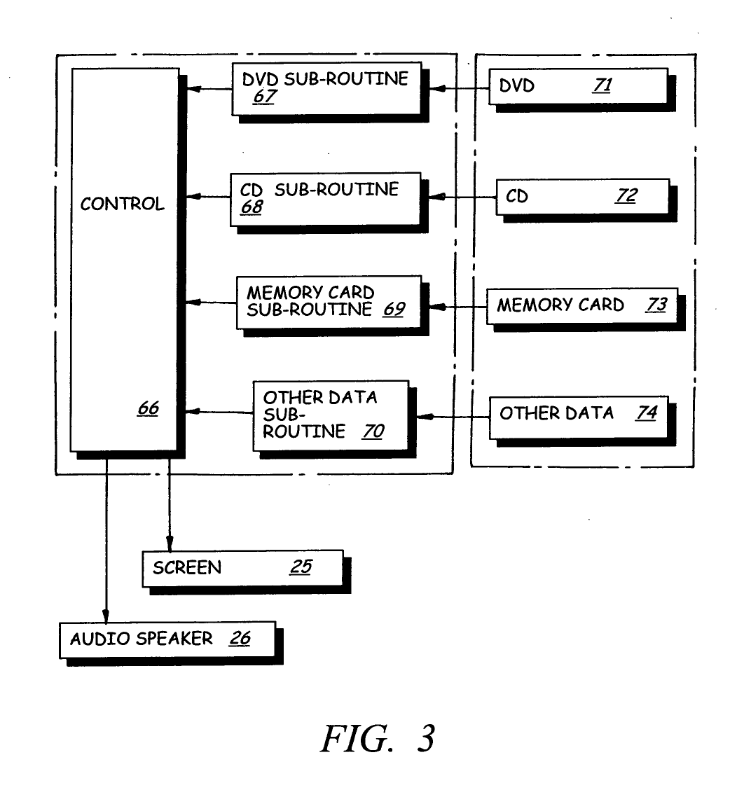

FIG. 3 is a block diagram illustrating a control system constructed in accordance with the invention; and,

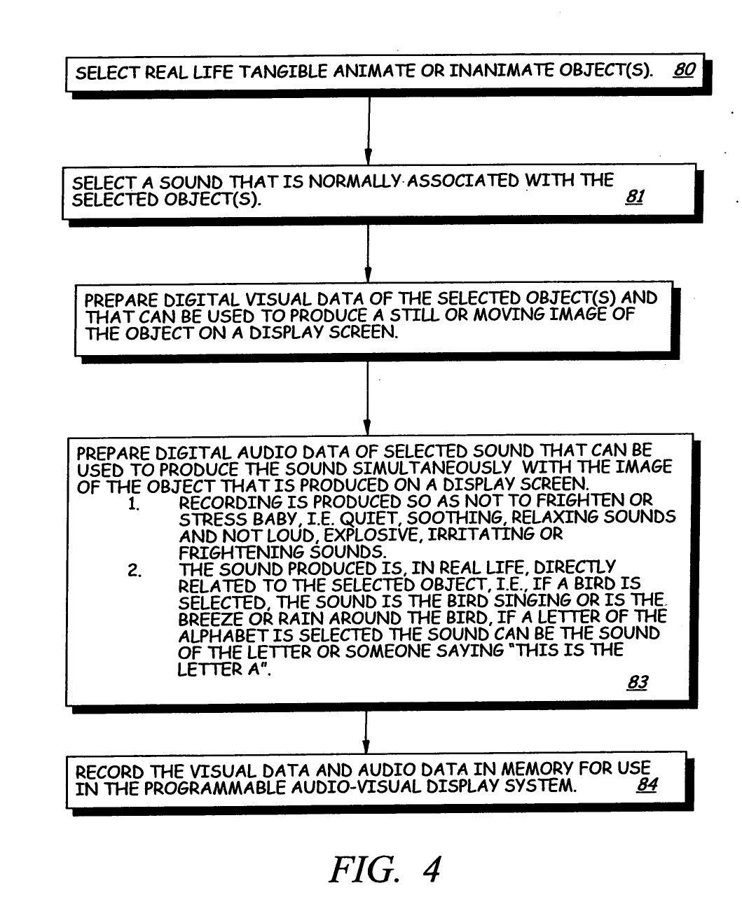

FIG. 4 is a block flow diagram illustrating the generation of real life audio-visual correlation models in accordance with the invention.

Briefly, provided is an improved method to facilitate the development of a baby zero to six months old while lying on its back in a baby crib. The crib includes a frame including a bottom and four sides, and a mattress on and supported by the bottom. The improved method comprises the steps of generating data defining a plurality of audio-visual correlation models of real life situations, each of said audio-visual correlation models including a video portion, and an audio portion directly correlated to the video portion; and, providing a developmental programmable audio-visual display system. The developmental programmable audio-visual display system includes a mounting arm with a distal end and with a proximate end attachable to one of a pair consisting of the bottom of the baby crib and the sides of the baby crib; a two dimensional display screen mounted on the distal end of the arm, and an audio speaker. The display system is programmable to process the data defining the audio-visual correlation models, to generate the video portion on the display screen, and, to generate the audio portion on the audio speaker concurrently with the video portion on said display screen. The mounting arm can be manipulated to position the display screen above and generally parallel to the mattress. The method also includes the steps of programming the display system with the data defining the audio-visual correlation models of real life situations; determining the age of the baby in months; defining the distance above the mattress to position the two dimensional display screen based on the age of the baby; selecting the time of day to operate the audio-visual display system; attaching the audio-visual display to one of the sides of the crib; manipulating the mounting arm to position the audio-visual display the defined distance above and generally parallel to the mattress; selecting at least one of the video-audio correlation models; and, playing at the selected time of day the selected video-audio correlation model for the baby.

Turning now to the drawings, which depict the presently preferred embodiments of the invention for purposes of illustration and not by way of limitation of the invention, and in which like reference characters correspond to like elements throughout the several view, FIG. 1 illustrates a baby crib generally indicated by reference character 10 and including sides 11, 12, 13, including bottom 14, and including mattress 15 on bottom 14. Baby 16 is lying on its back on mattress 15. Developmental programmable audio-visual display system 20 includes a mounting arm with interconnected articulating sections 21, 22, 23. The proximate end of section 21 is connected to a side 11-13 or the bottom 14 of crib 10, and can alternatively also, if desired, be connected to a wall, a ceiling, or mounted on the floor. The distal end of arm 21 is connected to the proximate end of arm 22. The distal end of arm 22 is connected to the proximate end of arm 23. The distal end of arm 23 is connected to display 24. Display 24 includes two dimensional screen 25. Screen 25 can comprise a CRT screen, LCD screen or any other desired kind of screen on which data defining the video portion of an audio-visual correlation model can be produced. The size of screen 25 can vary as desired; however, it is preferably preferred that the screen 25 be relatively small and be sized to fit within the confines of a baby crib since when a baby 16 is young the screen 25 need be positioned in the near vicinity of the baby. In alternate embodiments of the invention the screen can be significantly larger, particularly when used with a baby that is older than five or six months, or when used with children.

### The Mounting Arm

The orientation of each articulating sections 21, 22, 23 of the mounting arm is adjustable. This enables the mounting arm to function to permit display 24 and screen 25 to be positioned desired distances above mattress 15 (i.e., above baby 16) in an orientation in which screen 25 is generally parallel to mattress 15 and, since mattress 15 normally is parallel to the floor, to the floor (not shown) on which crib 10 sets. The construction of the mounting arm can vary as desired. Existing articulating arms ordinarily can not be readily substituted into the system of the invention because they are designed to maintain a screen 25 in a substantially horizontal orientation for viewing and because they are not intended to be mounted on a baby crib.

### The Two Dimensional Screen

Screen 25 is generally flat and is therefore two-dimensional. Screen 25 can be slightly concave or convex to facilitate operation or viewing of the screen. The purpose, however, of screen 25 is to produce an image on a two-dimensional surface. Mobiles typically include three-dimensional objects and parts that are varying distances from the baby. Such objects, when viewed by a baby, facilitate the development of the baby's eyes and depth perception and the ability of the baby to see objects at differing distances from the baby. The invention is not, however, intended to present three dimensional objects to facilitate the ability of a baby's eyes to focus on objects positioned at differing distances from the baby. Instead, it is important that the baby be able as best it can to focus on and view the video produced in screen 25, and that the baby not be concentrating on focusing its eyes on objects at varying distance from the baby.

### Positioning the Display Screen

Positioning of a mobile requires less precision because the mobile and objects comprising the mobile typically are varying distances from the baby so that at any given time a part of the mobile lies within the baby's “best focus” range. Positioning the display screen 25 is more important in the practice of the invention and preferably should be accomplished in the baby's “best focus” range. As the baby gets older, the baby's eyes mature, the “best focus” range increases, and it is a simpler matter to position screen 25 a distance from the baby that is in the best focus range. In addition, as the baby get older, the ability of the baby's eyes to clearly see an object also increases until the baby can normally see objects with 20/20 vision.

One way in which the distance from the crib mattress. i.e., from the baby's eyes, of screen 25 is determined is by utilizing accepted medical data. For example, one source of medical data indicates that during the first month after birth, a baby can only focus on objects that are about six inches away. This means the “best focus” range is small and is equal to about six inches plus or minus one-half inch. During the second month, a baby can focus on objects that are about six to eight inches away. This means the “best focus” range has increased to a size of two inches (i.e., eight inches minus six inches). And during the third and fourth months he or she can focus on objects six to fifteen inches away. This means the “best focus” range has increased to a size of nine inches. And during the fifth and sixth months he or she can focus on objects six to twenty-four inches away or more.

Another way to determine the “best focus” range is by simple experimentation. For example, shortly after birth, a baby often initially reacts most to his or her mother's face. A picture of the baby's Mom (or some other desired picture or object) can be placed at different distances from the baby to determine when the baby most reacts to the picture. Or the baby's mother can lean over a crib railing to see the distance from the baby at which the baby appears most to react to her face.

### Programmable Display System

The display system of the invention is programmable and utilizes a control software program to accept and manage different memory formats that provide video and/or audio data. By way of example, and not limitation, the display system preferably can accept and process text files, JPEG files, AVI files, MPEG-1 files, MPEG-2 files, MPEG-4 files, and MP3 files.

A memory format can comprise hardware or software.

One example of memory format hardware is a SD, MMC, CF, MS, or XD memory card. The display 24 can include a USB or other port into which the memory card is inserted to be read.

Another example of memory format hardware is a small memory unit or “hard drive” that is plugged into a USB port. Display 24 or the mounting arm can include the USB port or other port, or display 24 can be connected via wire or wireless to a computer or other data input unit that includes the USB port or other port.

A further example of memory format hardware is a DVD disc that is inserted in a DVD player that is part of or attached to or in communication with display 24.

One example of memory format software is internal memory that can be included in display 24, in the mounting arm, or in a remote computer in communication with display 24. This internal memory can include audio-visual data that is produced on screen 25.

As noted, the control software program (i.e. algorithm) controls how a part or all of the audio-visual data in a memory format is displayed on screen 25. The control software program can be stored in display 24 or in the mounting arm or in a computer or other hardware connected to display 24. The control software program can, for example, determine how and when a portion of audio-visual data stored in a memory format is displayed on screen 25 and is produced on a speaker that is mounted in display 24 or elsewhere. For example, the control software program can cause only certain pictures and associated sound to be produced on screen 25 and its associated speaker. Or, the control software program can cause only one picture or video and its associated sound to be displayed for a selected period of time, say for example, ten seconds. Or, the control software program can cause audio-visual data to be produced by the audio-visual display system only at a certain time(s) of day. In general, the audio-visual display system of the invention is not intended to be utilized for long periods of time. When a baby is young, it spends much of its time sleeping and eating, and does not need to be subjected to an audio-visual display system for extended periods of time. The audio-visual display system can be utilized for as long a desired, but typically is only initially is utilized only for a few minutes, or until the baby falls asleep or becomes interested in other activity. As the baby grows older, the length of time during which a baby views the audio-visual system typically can be increased as desired.

An example of a microprocessor or other computer control for the audio-visual system of the invention is depicted in FIG. 3 and includes a memory including a DVD 71, CD 72, memory card 73, or other data 74. The control 66 receives input from DVD sub-routine 67, CD sub-routine 68, memory card sub-routine 69, and other data sub-routine 70. These sub-routines receive data input from the memory. Control 66 outputs to screen 25 and speaker 26 (FIG. 1) data to produce a video display on screen 25 and sound emanating from speaker 26. The microprocessor or other computer control can be located in display 24, can be located in the mounting arm and be in communication with display 24, or, can be located in a computer that is directly attached to or is remote from display 24 and that communicates via wire or wireless with display 24 and speaker 26. Speaker 26 can be mounted in or on display 24 or, can be located remote from display 24 to produce—simultaneously with a video on screen 25—sound within ear shot of the baby 16 that correlates with the video produced in screen 25.

### Real Life Audio-Visual Correlation Models (RLAVCMs)

Mobiles typically do not produce real life audio-visual correlation models (RLAVCMs) or enable a baby to become familiar with and adapt to a real life audio-visual situation. For example, if a mobile includes a plastic star that is suspended on a string and plays the song “Twinkle, twinkle, little star”, that likely is relaxing and beneficial to a baby and comprises an audio-visual correlation model (AVCM) but does not produce a real life audio-visual correlation model (RLAVCM) because when you look at a star in the sky in the natural there normally is no music playing, namely, “Twinkle, twinkle little star” is not playing. If, on the other hand, a picture or video of a real cardinal (bird) is shown accompanied by the sound of the cardinal chirping, that is a real life audio-visual correlation model. Or if the letter A is shown along with the sound of someone pronouncing the letter A, that is a real life audio-visual correlation model (RLAVCM). Or, if the word “Obedience” is shown along with the sound of someone pronouncing the word “Obedience”, that is a real life audio-visual correlation model. Or if a picture of a real tree is shown along with the sound of the breeze rustling the leaves in the tree, that is a real life audio-visual correlation model. While the audio-visual system of the invention can be utilized to produce audio-visual correlation models (AVCMs) like the star—“Twinkle, twinkle, little star” scenario noted above, one of the principal objectives of the invention is to utilize the audio-visual system to produce and prepare the baby for real life audio-visual correlation models that the baby will encounter as it grows up. The baby likely will not understand the audio-visual correlation models that it sees, but the models will, at least in part, be imprinted in the baby's mind to be consciously or subconsciously recalled at a later time and to facilitate training the baby to be a productive member of society. The audio-visual system of the invention can also be utilized to produce only a video or still picture (without accompanying sound), or can be utilized to produce only sound (without an accompanying video). FIG. 2 illustrates screen 25 with a video representation of bubbles 26, 27, 28, 29 moving in random directions indicated by arrows A, B, C and “bouncing” around inside and off the “sides” of two-dimensional screen 25 and off each other. The two dimensional screen 25 enables a baby to focus more easily on the subject matter displayed on screen 25.

The process to produce a real life audio-visual correlation model is summarized in FIG. 4 and includes the steps of “select a real life tangible animate and/or inanimate object(s)” 80, “select a sound that is normally associated with the selected object(s)” 81, and “prepare digital visual data of the selected object(s) and that can be used to produce a still or moving image of the object on a display screen”.

The process also includes the step of “prepare digital audio data of selected sound that can be used to produce the sound simultaneously with the video image of the object that is produced on a display screen” 83. The digital audio data sound recording is produced so as not to frighten or stress a baby, i.e., quiet, soothing, relaxing sounds are utilized and not loud, explosive, irritating or frightening sounds. The sound produced is, in real life, directly related to the selected object. If a bird is selected, the sound is the bird singing or is the breeze or rain around the bird. If a letter of the alphabet is selected, the sound can be the sound of the letter or “This is the letter A”.

The last step in the process is “record the visual data and audio data in memory for use in the programmable audio-visual display system” 84.

Examples of real life audio-visual correlation models (RLAVCMs) are described below. As would be appreciated by those of skill in the art, the correlation models selected and used can vary widely, can if desired include some of those listed below, or can include any other desired real life correlation models.

### RLAVCM: Nature

Rationale: The rationale of the nature correlation model is that it is important for an individual to have an appreciation of nature, and that one way to help gain such an appreciation is to introduce children to nature at an early age.

TABLE I
REAL LIFE AUDIO-VISUAL NATURE CORRELATION MODELS

| CORRELATION | | | SOUND SOURCE |
|---|---|---|---|
| MODEL VIDEO | | RELATED | ACCOMPANYING |
| TOPIC | MOVEMENT | AUDIO | VIDEO |
| Motion picture of | Yes: Baby seal | Natural | Recorded from |
| baby seal. | crawling over the | sounds of | nature. |
| | snow. | seal | |
| | | crawling | |
| | | over the | |
| | | ice, and of | |
| | | the wind. | |
| Motion picture of | Yes. Clouds | Natural | Recorded from |
| white “cotton | moving through | sounds of | nature. |
| ball” clouds in | sky. | the breeze | |
| a blue sky. | | and birds | |
| | | chirping. | |
| Still picture of | No. | Birds | Recorded from |
| tulip. | | chirping or | nature. |
| | | other | |
| | | sounds of | |
| | | nature. | |

### RLAVCM: Music

Rationale: The rationale of the music correlation model is that music relates to nearly every individual and is effective in helping a baby relax and learn. It is important for an individual to be exposed to various forms of music. Mozart and other composers have been shown to assist learning. Babies can occasionally be exposed to music that is more complicated than nursery rhymes played one note at a time.

TABLE II
REAL LIFE AUDIO-VISUAL MUSIC CORRELATION MODELS

| CORRELATION | | | SOUND SOURCE |
|---|---|---|---|
| MODEL VIDEO | | RELATED | ACCOMPANYING |
| TOPIC | MOVEMENT | AUDIO | VIDEO |
| Motion picture of | Yes: Orchestra | Music that | Sound recording of |
| symphony | members move | symphony | the orchestra |
| orchestra playing. | as they play | orchestra is | playing the |
| | instruments and | playing. | music. |
| | camera | | |
| | pans over | | |
| | orchestra. | | |
| Still picture of a | No. | The sound | Sound recording of |
| music note as it | | made when a | middle C played on |
| would appear on | | middle C is | grand piano; or, |
| sheet music, such | | sung or is | sung. |
| as the middle C. | | played on the | |
| | | piano or | |
| | | another | |
| | | musical | |
| | | instrument.. | |
| Still picture of | No. | Music by | Symphony orchestra |
| Mozart. | | Mozart | recording of music |
| | | | written by Mozart. |

### RLAVCM: Character

Rationale: The rationale of the character model is that an individual becomes a better contributing member of society if he realizes there are universal desirable character traits such as honesty, honor, hard work, respect, etc. and that each individual does not decide and only do “what is best for him”. A knowledge of such character traits is important in helping people think and rationally analyze situations. It is important for an individual to be exposed to universally accepted character traits at an early age.

TABLE III
REAL LIFE AUDIO-VISUAL CHARACTER CORRELATION MODELS

| CORRELATION | | | SOUND SOURCE |
|---|---|---|---|
| MODEL VIDEO | | | ACCOMPANYING |
| TOPIC | MOVEMENT | RELATED AUDIO | VIDEO |
| Motion picture of | Yes: Natural | Boy and | Sound recording of |
| boy being asked by | movements of boy | mother talking | video participants |
| mother if he took a | and mother during | and | talking. |
| cookie. Boy says | their conversation. | pronunciation | |
| “Yes” and mom | | of the word | |
| says “Thank you | | “HONEST” by | |
| for being honest.” | | the baby's | |
| Then the word | | mother. | |
| “HONEST” appears | | | |
| and is pronounced | | | |
| by the baby's Mom. | | | |
| Motion picture of | Yes. Natural | Woman | Sound recording of |
| man opening door | movements of man | saying thank | woman saying thank |
| for woman and | and woman and of | you. | you. |
| woman saying | door being opened | | |
| “Thank you.”. | and closed. | | |
| Still picture of | No. | Baby's Dad | Sound recording of |
| Abraham Lincoln | | saying | baby's Dad saying |
| hewing a log with | | “MAKE | “Make friends with |
| an axe. | | FRIENDS | work.” (This is real life |
| | | WITH | because it is something |
| | | WORK.” | Dad would say.) |
| Still picture of | No. | Baby's Mom | Sound recording of |
| “MAKE FRIENDS | | saying “MAKE | baby's Mom saying |
| WITH WORK”. | | FRIENDS | “Make friends with |
| | | WITH | work.” |
| | | WORK.” | |

### RLAVCM: Language

Rationale: The rationale of the language music correlation model is that a knowledge of language and vocabulary are important in enabling a person to think and communicate.

TABLE IV
REAL LIFE AUDIO-VISUAL LANGUAGE CORRELATION MODELS

| CORRELATION | | | SOUND SOURCE |
|---|---|---|---|
| MODEL VIDEO | | RELATED | ACCOMPANYING |
| TOPIC | MOVEMENT | AUDIO | VIDEO |
| Motion picture of a | Yes: Natural | Baby's Mom | Sound recording of |
| cat sitting and | movements of cat. | saying “Cat.” | baby's Mom saying |
| looking around. | | | “Cat” in English (or |
| | | | French, Italian, etc.) |
| Still picture of a | No. | Woman | Sound recording of |
| cat. | | saying “Cat.” | woman saying “Cat” in |
| | | | English (or French, |
| | | | etc.). |
| Still picture of the | No. | Woman | Sound recording of |
| word “cat”. | | saying “Cat”. | woman saying “Cat.” |
| Still picture of the | No. | Baby's Mom | Sound recording of |
| letter “A”. | | pronouncing | baby's Mom |
| | | the letter “A”. | pronouncing the letter “A”. |

### RLAVCM: Pride in Country

Rationale: The rationale of the pride in country correlation model is that the United States, although it certainly has its drawbacks and areas in which it can improve, is a great country and that we should be proud of its accomplishments and positive characteristics.

TABLE V
REAL LIFE AUDIO-VISUAL PRIDE IN COUNTRY CORRELATION
MODELS

| CORRELATION | | | SOUND SOURCE |
|---|---|---|---|
| MODEL VIDEO | | RELATED | ACCOMPANYING |
| TOPIC | MOVEMENT | AUDIO | VIDEO |
| Motion picture of | Yes: Camera | Spoken | Sound recording of |
| the Lincoln | pans over | recitation of | recitation of |
| memorial in | statue of | the | Gettysburg |
| Washington DC. | Lincoln sitting | Gettysburg | address. |
| | in chair. | address. | |
| Still picture of | No. | Performance | Sound recording of |
| George | | by the song | Kate Smith singing |
| Washington with | | “America” by | “America.” |
| the words “Father | | Kate Smith. | |
| of our Country” | | | |
| underneath. | | | |
| Still picture of | No. | Baby's Dad | Sound recording of |
| Abraham Lincoln | | saying | baby's Dad saying |
| hewing a log with | | “MAKE | “Make friends with |
| an axe. | | FRIENDS | work.” |
| | | WITH | |
| | | WORK.” | |
| Still picture of | No. | Baby's Mom | Sound recording of |
| “MAKE | | saying “MAKE | baby's Mom saying |
| FRIENDS WITH | | FRIENDS | “Make friends with |
| WORK”. | | WITH | work.” |
| | | WORK.” | |

### RLAVCM: Parental Relationship

Rationale: The rationale of the parental relationship correlation model is that if the parents don't get along, if Dad doesn't appear to love Mom and treat her well, this can have an adverse affect on the baby's becoming a normal, grounded, contributing member of society.

TABLE VI
REAL LIFE AUDIO-VISUAL PARENTAL RELATIONSHIP
CORRELATION MODELS

| CORRELATION | | | SOUND SOURCE |
|---|---|---|---|
| MODEL VIDEO | | RELATED | ACCOMPANYING |
| TOPIC | MOVEMENT | AUDIO | VIDEO |
| Motion picture of | Yes: Natural | Mom and Dad | Sound recording of |
| Mom and Dad | movement of Mom | saying “I love | Mom and Dad speaking |
| hugging and saying | and Dad as they | you.” | to each other. |
| “I love you” to each | hug and talk to each | | |
| other. | other. | | |
| Motion picture of | Yes: Natural | Mom saying | Sound recording of |
| Dad opening car | movement of Mom | “Thank you.” | Mom saying “Thank |
| door for Mom and | and Dad opens | | you.” |
| Mom saying | door, Mom gets in | | |
| “Thank you.” as | car, and Dad closes | | |
| she gets in car and | door. | | |
| Dad closes door. | | | |
| Motion picture of | Yes: Natural | Mom and Dad | Sound recording of |
| Mom and Dad | movement of Mom | laughing. | Mom and Dad laughing. |
| smiling and | and Dad as they | | |
| laughing together | laugh and watch | | |
| as they watch a | movie. | | |
| movie. | | | |

### RLAVCM: Attitude

Rationale: The rationale of the attitude correlation model is the theory that negative, unhappy people lead shorter lives, are more likely to develop disease, tend to be detrimental, and often don't help others improve or advance and that, accordingly, that it is advantageous to grow up with a positive outlook on life.

TABLE VII
REAL LIFE AUDIO-VISUAL ATTITUDE CORRELATION MODELS

| CORRELATION | | | SOUND SOURCE |
|---|---|---|---|
| MODEL VIDEO | | RELATED | ACCOMPANYING |
| TOPIC | MOVEMENT | AUDIO | VIDEO |
| Motion picture of | Yes: Animation | Jiminy singing | Sound recording of |
| Jiminy Cricket | makes Jiminy move | the song. | Jiminy singing the |
| singing the song | while he sings the | | song. |
| “When you wish | song. | | |
| upon a star . . .” | | | |
| Still picture of the | No. | Dad reading | Sound recording of Dad |
| words “FIND | | the words. | reading the words. |
| FRIENDS WHO | | | |
| ARE HAPPY, OF | | | |
| GOOD | | | |
| CHARACTER, | | | |
| AND MAKE YOU | | | |
| BETTER.” | | | |
| Still picture of the | No. | Mom reading | Sound recording of |
| words “AVOID | | the words. | baby's Mom saying the |
| FRIENDS WHO | | | words. |
| ARE UNHAPPY, | | | |
| OF POOR | | | |
| CHARACTER, | | | |
| AND WHO DON'T | | | |
| SUPPORT YOU.” | | | |
| Motion picture of | No. | Mickey saying | Sound recording of |
| Mickey Mouse | | the words. | Mickey saying the |
| saying“BELIEVE | | | words. |
| GOOD THINGS | | | |
| WILL HAPPEN. | | | |
| HAVE A SENSE | | | |
| OF HUMOR.” | | | |

### RLAVCM: Obedience

Rationale: The rationale of the obedience correlation model is that when a parent's job is made easier when a child is obedient. Exposing a baby to the concept of obedience may later facilitate the parent's teaching the baby to be obedient when it becomes older.

TABLE VIII
REAL LIFE AUDIO-VISUAL OBEDIENCE
CORRELATION MODEL

| CORRELATION | | | SOUND SOURCE |
|---|---|---|---|
| MODEL VIDEO | | RELATED | ACCOMPANYING |
| TOPIC | MOVEMENT | AUDIO | VIDEO |
| Still picture of the | No. | Mom reciting | Sound recording of |
| words:“1st TIME | | the words. | Mom reciting the |
| OBEDIENCE: | | | words. |
| IMMEDIATE, | | | |
| COMPLETE, NO | | | |
| COMPLAINING, | | | |
| NO ARGUING.” | | | |

### Use of Invention

In use, a plurality of real life audio-visual correlation models are selected and data is generated that for each correlation model to define a video portion and an audio portion directly correlated to the video portion.

A developmental programmable audio-visual display system is provided. The system includes a mounting arm with a distal end and with a proximate end or section 21 attachable to one of a pair consisting of the bottom of the baby crib and the sides of the baby crib 10. The system also includes a two dimensional display screen 25 mounted on the distal end of the arm, and an audio speaker 26. The system is programmable to process the data defining the real life audio-visual correlation models, to generate the video portion on the display screen, and to generate the audio portion on the audio speaker concurrently with the video portion on the display screen. The system is programmed with desired software programs 67 to 70 and audio and/or video data 71 to 74. The audio-visual data can comprises data defining the audio-visual correlation models of real life situations. The programmable audio-visual system can be programmed by placing the data on a DVD 71, CD 72, memory card 73, or other data storage unit and by inserting the data storage unit in a receiving slot in display 24, in the mounting arm, or in a unit that is remote from and communicates with the display system. The data can also be input and stored in internal memory in the programmable audio-visual display system.

In one preferred embodiment of the invention, the real life audio-visual correlation models include videos in which there is movement (i.e., a moving animal, an orchestra playing, the letter “A” moving across the display screen, etc.) and sound. The correlation of the subject matter of the model with sound and movement is believed to help imprint the subject matter in the baby's mind.

The age of the baby in months is determined and the distance above the mattress at which to position the two dimensional display screen 25 is defined based on the age of the baby.

The time(s) of day and length of each period(s) of time to operate the audio-visual display system is selected and section 21 of the mounting arm is attached to the crib 10.

The mounting arm is used to position screen 25 said defined distance above the mattress in an orientation generally parallel to the mattress.

At least one of the video-correlation models is selected and played at said selected time of day.

The system of the invention can include apparatus to project a holographic image above the baby either in or above the crib; or, to project a holographic image laterally from the crib that a baby can see while on its side and looking out through the spaced apart vertically oriented posts or rails that comprise the sides of the crib.

Having described our invention in such terms as to permit those of skill in the art to understand and practice it, and having presently the presently preferred embodiment thereof, we Claim:

1. A method to facilitate the development of a baby zero to six months old while lying on its back in a baby crib, the crib including
a frame including a bottom and four sides, and
a mattress on and supported by the bottom,
the method comprising the steps of
(a) generating data defining a plurality of audio-visual correlation models of real life situations, each of said audio-visual correlation model including
(i) a video portion, and
(ii) an audio portion directly correlated to said video portion;
(b) providing a developmental programmable audio-visual display system with
(i) a mounting arm with a distal end and with a proximate end attachable to one of a pair consisting of the bottom of the baby crib and the sides of the baby crib,
(ii) a two dimensional display screen mounted on said distal end of said arm, and
(iii) an audio speaker,
said display system programmable to
(i) process said data defining said audio-visual correlation models,
(ii) generate said video portion on said display screen;
(iii) generate said audio portion on said audio speaker concurrently with said video portion on said display screen, and
said arm adjustable to position said two dimensional display screen generally parallel to the mattress of the crib;
(c) programming said display system with said data defining said audio-visual correlation models of real life situations;
(d) determining the age of the baby in months;
(e) defining the distance above said mattress to position said two dimensional display screen based on the age of the baby;
(f) selecting the time of day to operate said audio-visual display system;
(g) attaching said audio-visual display to one of said sides of said crib;
(h) manipulating said arm to position said audio-visual display said distance above said mattress in an orientation generally parallel to the mattress;
(i) selecting at least one of said video-audio correlation models; and
(j) playing at said selected time of day said selected video-audio correlation model for the baby.
